(19) United States
(12) Patent Application Publication
(10) Pub. No.: US 2013/0254730 A1
(43) Pub. Date: Sep. 26, 2013

(54) LAYOUT SYSTEM AND METHOD OF CREATING DIFFERENTIAL PAIR ON PRINTED CIRCUIT BOARD

(71) Applicants: HONG FU JIN PRECISION INDUSTRY (ShenZhen) CO., LTD., (US); HON HAI PRECISION INDUSTRY CO., LTD., New Taipei (TW)

(72) Inventors: GUANG-FENG OU, Shenzhen (CN); YONG-ZHAO HUANG, Shenzhen (CN)

(73) Assignees: HON HAI PRECISION INDUSTRY CO., LTD., New Taipei (TW); HONG FU JIN PRECISION INDUSTRY (Shenzhen) CO., LTD., Shenzhen (CN)

(21) Appl. No.: 13/775,107

(22) Filed: Feb. 22, 2013

(30) Foreign Application Priority Data
Mar. 26, 2012 (CN) 201210081890.4

(51) Int. Cl. G06F 17/50

(52) U.S. Cl. CPC G06F 17/5077
USPC 716/112

(57) ABSTRACT

A layout method for the creation of a differential pair for the transmission of signals generates a differential pair between a differential signal sender and a differential signal receiver in a layout of a PCB. Differential signals are transmitted via two wires. A plurality of vertical lines are created on the differential pair. Junctions of the vertical lines and the two wires are defined as pairs of points. A first length between one terminal of the differential signal sender and one point of each pair of points and a second length between the other terminal of the differential signal sender and the other point of each pair of points are calculated. If any difference between the first length and the second length does not fall within an allowable range, the lengths of the two wires are adjusted.

### BACKGROUND

1. Technical Field

The disclosure generally relates to layout systems and methods, and particularly to a layout system and method of creating a differential pair on a printed circuit board (PCB).

2. Description of Related Art

In PCB design, a differential pair is a pair of wires used for differential signaling, where two wires of the differential pair have a same length. However, in a breakout section of the differential pair, there is a non-parallel section that may cause the lengths of the two wires of the differential pair to be different. In addition, the differential pair should be arranged around electronic components on the PCB which may also cause lengths of the two wires to be different. If the lengths of the two wires are different, the differential pair may cause electromagnetic interference (EMI), which can damage circuits of the PCB.

Therefore, there is room for improvement within the art.

### BRIEF DESCRIPTION OF THE DRAWINGS

Many aspects of the embodiments can be better understood with reference to the drawings. The components in the drawings are not necessarily drawn to scale, the emphasis instead being placed upon clearly illustrating the principles of the disclosure.

FIG. 1 shows a block diagram of one embodiment of a computing device comprising a layout system.

FIG. 2 shows a schematic diagram illustrating one embodiment of a layout of a differential pair.

FIG. 3 shows a block diagram of one embodiment of function modules of the layout system shown in FIG. 1.

FIG. 4 and FIG. 5 cooperate to show a flowchart of one embodiment of a layout method of creating a differential pair.

### DETAILED DESCRIPTION

In general, the word “module,” as used herein, refers to logic embodied in hardware or firmware, or to a collection of software instructions, written in a programming language, such as, for example, Java, C, or assembly. One or more software instructions in the modules may be embedded in firmware, such as in an EPROM. Modules may comprise connected logic units, such as gates and flip-flops, and may comprise programmable units, such as programmable gate arrays or processors. The modules described herein may be implemented as either software and/or hardware modules and may be stored in any type of non-transitory computer-readable medium or other computer storage device. Some non-limiting examples of non-transitory computer-readable mediums include DVDs, CDs, and hard disk drives.

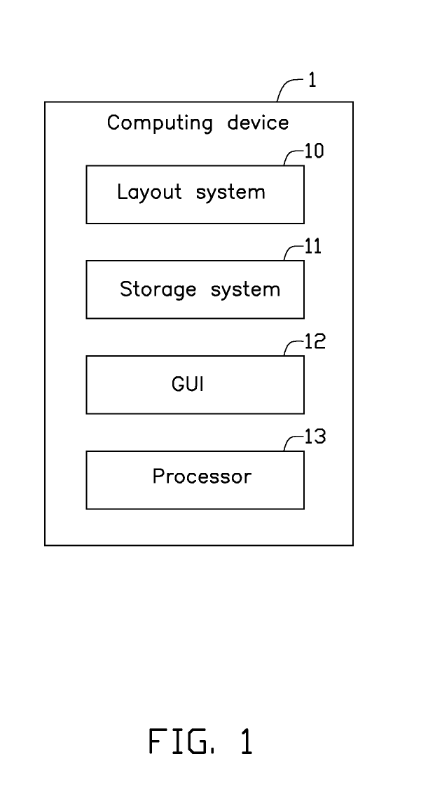

FIG. 1 shows a block diagram of one embodiment of a computing device 1 comprising a layout system 10. The computing device 1 includes a storage system 11, and a graphical user interface (GUI) 12. The storage system 11 stores a layout of a PCB (not shown) having a plurality of components. The layout of the PCB includes emulations of the components of the PCB. In some embodiments, the components may be negative parts, that is, via holes, or screw holes. The GUI 12 displays the layout of the PCB.

The layout system 10 can be used to design a layout of differential pairs on the PCB, e.g., the layout system 10 may be used to create a differential pair between a differential signal sender and a differential signal receiver on the PCB for transmitting differential signals from the differential signal sender to the differential signal receiver. The differential pair includes two wires. The two wires may be twisted-pair cables. The differential pair includes three sections, i.e., a package section, a breakout section, and a trace section. A section of the two wires sealed in the differential signal sender is defined as the package section. A section of the two wires, which are not sealed, around the differential signal sender is defined as the breakout section. The trace section is the remaining section of the two wires.

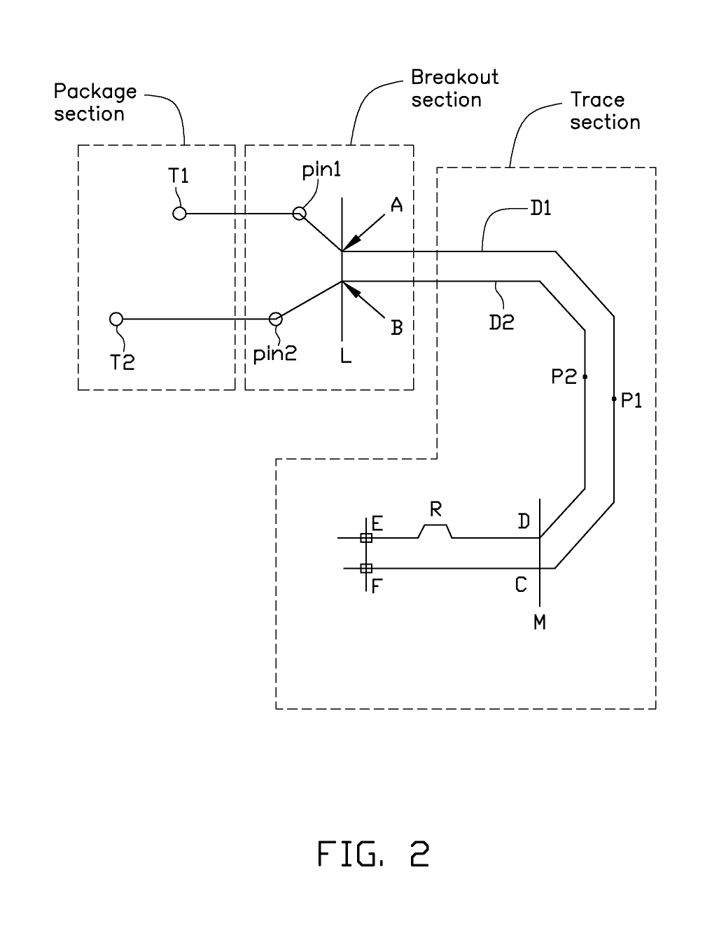

FIG. 2 is a schematic diagram illustrating one embodiment of a layout of a differential pair. The differential pair consists of wire D1 and wire D2. A signal generation terminal T1 and a signal generation terminal T2 are the terminals of the sender in the package section. Pin1 and pin2 are pins of the sender in the breakout section. The differential pair around the terminal T1 and the terminal T2 is the package section. The section of the differential pair around the pin1 and the pin2 is the breakout section. The breakout section of the differential pair further includes a parallel section and a non-parallel section. The parallel section means that the two wires are parallel. Differential signals are generated at the terminals T1 and T2 in the package section, and are transmitted from the breakout section to the trace section. The two wires D1 and D2 of the differential pair in the trace section are also parallel.

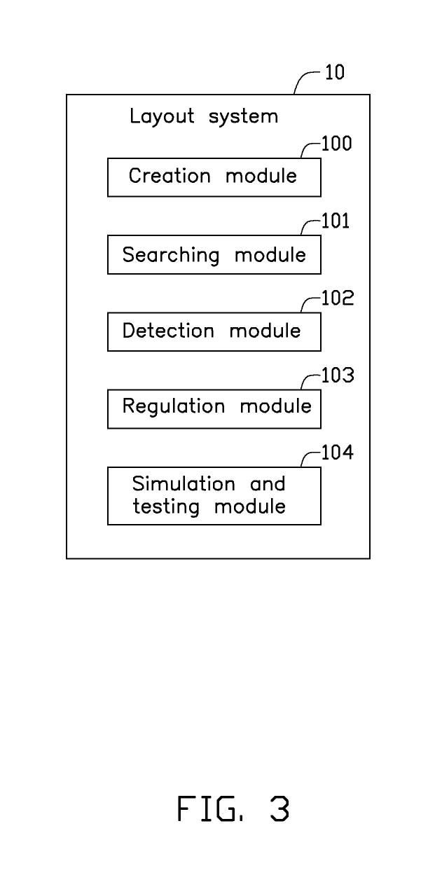

FIG. 3 shows a block diagram of one embodiment of function modules of the layout system 10 shown in FIG. 1. In an exemplary embodiment, the computing device 1 further includes at least one processor 13. The layout system 10 may include one or more modules. The one or more modules may comprise computerized code in the form of one or more programs that are stored in the storage system 11 (or memory). The computerized code includes instructions that are executed by the at least one processor 13 to provide functions for the one or more modules.

In the exemplary embodiment, the layout system 10 includes a creation module 100, a searching module 101, a detection module 102, a regulation module 103, and a simulation and testing module 104. The creation module 100 establishes the differential pair (the two wires D1 and D2) between the differential signal sender and the differential signal receiver. The layout of the PCB further includes a plurality of components located in the trace section.

The searching module 101 searches for bends or curves or corner points (bend points) where one or both of the two wires deviate, and searches for components located in the trace section. For example, the searching module 10 can search for the bends, curves or corner point by using some special software or algorithm. The bend points include the junctions of the parallel section and the non-parallel section in the breakout section of the differential pair, and the remainder of the bend points are in the trace section. The creation module 100 creates a first vertical line at the junctions of the parallel section and the non-parallel section in the breakout section of the differential pair, creates a second vertical line at each bend point of an inner wire of the two wires at the bend, and creates a third vertical line at each component located in the trace section of the differential pair. Intersections of the vertical lines and the two wires, and intersections of the vertical lines and the two wires are separately defined as a pair of bend points.

In the exemplary embodiment, as shown in FIG. 2, D1 and D2 are the two wires of the differential pair. The searching module 101 searches for a point A and a point B which are the junctions of the parallel section and the non-parallel section in the breakout section. The creation module 100 creates the first vertical line that crosses the point A and the point B and is perpendicular to the parallel section of the differential pair. The point A and the point B are defined as a pair of bend points. The two wires D1 and D2 of the trace section include a bend point C and a bend point D. The wire D2 is the inner wire of the two wires at the bend. The creation module 100 creates the second vertical line at the bend point D. The second vertical line is perpendicular to the parallel section connected to the bend point D of the differential pair. There is a component on the point E of the wire D1 and a separate component on the point F of the wire D2. The creation module 100 creates the third vertical line through the point E and the point F. The third vertical line is perpendicular to the parallel section connected to the points E and F of the differential pair.

The detection module 102 calculates a first length between one terminal of the differential signal sender and a point of each pair of points on one wire, and calculates a second length between the other terminal of the differential signal sender and the other point of each pair of points on the other wire. For example, referring to FIG. 2, the point A and the point B are one pair of points. The first length between the terminal T1 and the point A is “a”. The second length between the terminal T2 and the point B is “b”. The detection module 102 further detects if there is any difference between the first length and the second length and if so, whether such difference falls within, an allowable range. Any difference between the first and second lengths is set as ΔS, and the allowable range of the difference ΔS is illustrated as follows:

A bit rate of the differential signals transmitted through the differential pair is set as X1 (bit/s), a transmission rate of the differential signals transmitted through the differential pair is set as X2 (mil/ns) (1 mil=1/1000 inch, 1 ns=1 nanosecond), that is X2*10⁹ (mil/s). Thus, each bit of a differential signal is transmitted at

$$\frac{X 2 * {10}^{9}}{X 1} mil .$$

A signal rise time Trise or a signal fall time Tfall of the differential pair is set to be equal to 1/N times of the time of transmission of one bit of a differential signal. Accordingly, the differential signals can be transmitted at

$$\frac{X 2 * {10}^{9}}{X 1 * N} mil .$$

within the signal rise time Trise or within the signal fall time Tfall. According to experimental verification, when the difference ΔS is lower than or equal to ⅕ (one fifth) of a transmission length of the differential signals within the signal rise time Trise or the signal fall time Tfall, the wires D1 and D2 can achieve an excellent electromagnetic coupling as a differential pair. Therefore, the allowable range of the difference ΔS can be from 0 mil to

$$\frac{X 2 * {10}^{9}}{5 * X 1 * N} mil ( 0 \leq Δ S \leq \frac{X 2 * {10}^{9}}{5 * X 1 * N} mil ) .$$

For example, if the bit rate X1 is 8 Gbit/s, the transmission rate X2 is 6000 mil/ns, and N=10, and the allowable range of the difference ΔS is from 0 mil to 15 mil.

If the difference between the first length and the second length falls outside of the allowable range, then the regulation module 103 adjusts the routes of two wires. D1 and D2 of the differential pair. For example, in one embodiment, the regulation module 103 inserts a twist or loop into the shorter one of the two wires D1 and D2 of the differential pair adjacent to the corresponding bend point. As shown in FIG. 2, the difference between the first length between the terminal T1 and the bend point C is “c”, and the second length between the terminal T2 and the bend point D is“d”. If the first length “c” is shorter than the second length “d”, and the difference between the first length “c” and the second length “d” is outside the allowable range, the regulation module 103 twists the wire D2 adjacent to the bend point D, to form a protrusion section R, thereby lengthening the wire D2, so that the difference between the first and second length “c” and “d” is canceled.

The simulation and testing module 104 establishes a simulation model of the layout of the PCB, and tests functionality of the layout of the PCB. For example, the simulation and testing module 104 detects phases of the differential signals respectively transmitted by two wires D1 and D2, and searches for a signal transmission capability by determining whether a difference between the phases of the differential, signals transmitted by the two wires D1 and D2 is 180°, and detects the EMI level of the layout by determining the coupling of the two wires D1 and D2. If the simulation of the layout as tested does not match the requirement, the regulation module 103 adjusts the lengths of the two wires D1 and D2 again for further decreasing the difference ΔS (e.g. by limiting the difference ΔS to a narrower allowable range), until the layout of the PCB passes the simulation test.

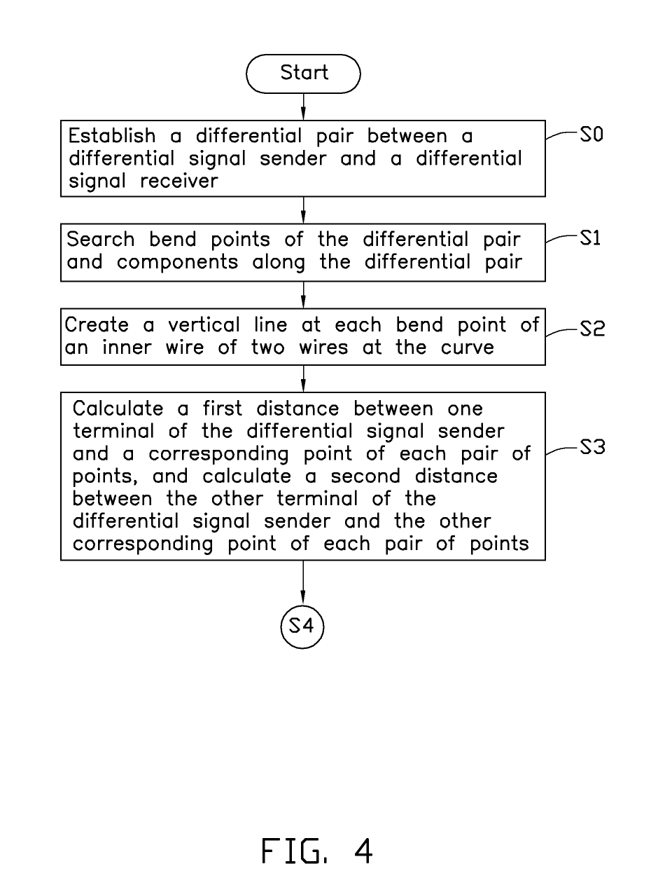

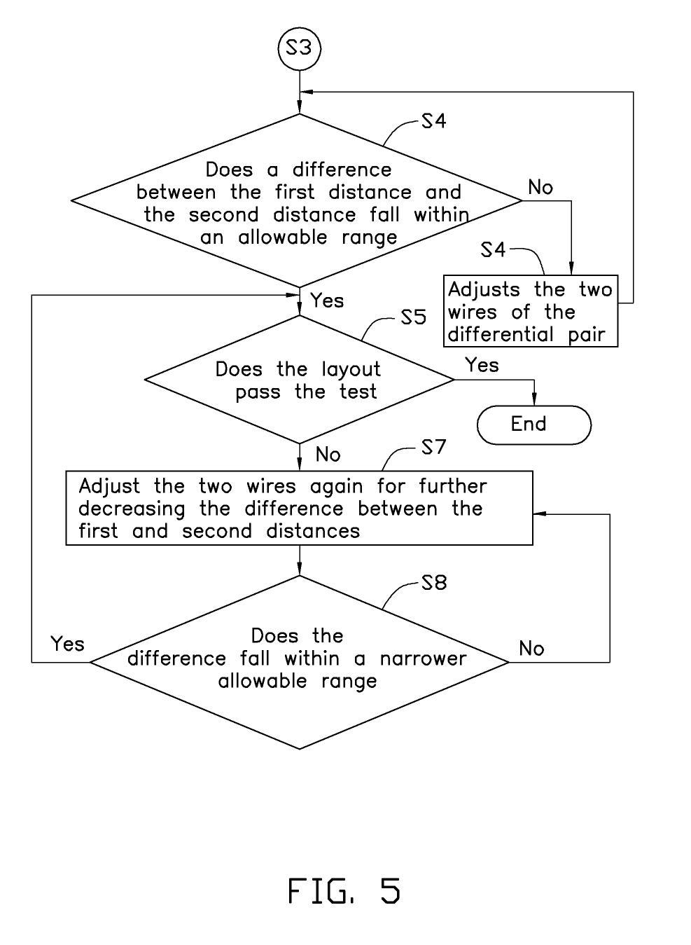

FIG. 4 and FIG. 5 cooperate to show a flowchart of one embodiment of a layout method of a differential pair. Depending on the embodiment, additional blocks may be added, others removed, and the ordering of the blocks may be changed.

Step S0, the creation module 100 establishes the differential pair (the two wires D1 and D2) between the differential signal sender and the differential signal receiver.

Step S1, the searching module 101 searches for bend points of the differential pair and components connected along the differential pair. The bend points include the junctions of the parallel section and the non-parallel section in the breakout section of the differential pair, and the remainder of the bend points are in the trace section.

Step S2, the creation module 100 creates a vertical line at the junctions of the parallel section and the non-parallel section in the breakout section of the differential pair, creates a vertical line at each bend point of an inner wire of the two wires at the bend, and creates a vertical line at the connection to each component located in the trace section of the differential pair. Intersections of the vertical lines and the two wires, and intersections of the vertical lines and the two wires are separately defined as a pair of bend points.

Step S3, the detection module 102 calculates a first length between one terminal of the differential signal sender and one point of each pair of points on one wire, and calculates a second length between the other terminal of the differential signal sender and the other point, of each pair of points on the other wire.

Step S4, the detection module 102 further detects whether there is a difference between the first length and the second length and if so whether the difference falls within an allowable range. If the difference falls within the allowable range, step S6 is executed. If any difference does not fall within the allowable range, step S5 is executed.

Step S5, the regulation module 103 adjusts the lengths of the two wires of the differential pair, and the procedure returns to step S3. In the exemplary embodiment, the regulation module 103 twists or loops the shorter one of the two wires of the differential pair adjacent to the bend point in question, to lengthen the shorter one of the two wires.

Step S6, the simulation and testing module 104 establishes a simulation model of the finished layout of the PCB, and tests the functionality of the layout of the PCB. If the layout of the PCB passes the test, the procedure ends. If the layout of the PCB does not pass the test, step S7 is executed. When testing the layout of the PCB, a length between a test point P1 (see FIG. 2) on the wire D1 and the terminal T1 should equal a length between a test point P2 on the wire D2 and the terminal T2, to ensure the precision of the test.

Step S7, the regulation module 103 adjusts the lengths of the two wires again for further decreasing any difference between the first and second lengths.

Step S8, the detection module 102 calculates the difference between the first and second length to each pair of bend points, and determines whether any difference is within a narrower allowable range. If any difference falls within the narrower allowable range, step S6 is executed. If one or more of the differences fall outside the narrower range, step S7 is executed.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A computing device, comprising:
a storage system;
at least one processor; and
one or more programs being stored in the storage system and executable by the at least one processor, the one or more programs comprising:
a creation module operable to establish a differential pair between a differential signal sender and a differential signal receiver in a layout of a printed circuit board (PCB), create a vertical line at each bend point of an inner wire of two wires at the bend and create a vertical line at a connection to each component of the PCB along the differential pair, wherein junctions of each vertical line and the two wires are separately defined as a pair of points;
a detection module operable to calculate a first length between one terminal of the differential signal sender and one point of each pair of points on one wire, and calculate a second length between the other terminal of the differential signal sender and the other point of each pair of points on the other wire;
a regulation module operable to adjust the lengths of the two wires of the differential pair if any difference between the first length and the second length does not fall within an allowable range; and
a simulation and testing module operable to establish a simulation model of the layout comprising the differential pair and the components of the PCB, and test the functionality of the layout of the PCB.

2. The computing device of claim 1, further comprising a searching module operable to search for the bend points of the two wires and components along the differential pair.

3. The computing device of claim 2, wherein the differential pair comprises a package section, the breakout section, and a trace section, the searching module operable to search for the junctions of a parallel section and the non-parallel section in the breakout section of the differential pair.

4. The computing device of claim 1, wherein the components comprises via holes, and screw holes.

5. The computing device of claim 1, wherein the regulation module adjusts the lengths of the two wires by twisting or looping the shorter one of the two wires of the differential pair adjacent to the bend point.

6. The computing device of claim 1, wherein the allowable range is from 0 mil to
$$\frac{X 2 * {10}^{9}}{5 * X 1 * N} mil ,$$
wherein X1 is a bit rate of differential signals transmitted through the differential pair; X2 is a transmission rate of the differential signals; and N is a ratio of a time of transmission one bit differential signals and a signal rise time of the differential pair.

7. A layout method of creating a layout of a differential pair, comprising:
establishing a differential pair between a differential signal sender and a differential signal receiver in a layout of a PCB;
creating a vertical line at each bend point of an inner wire of two wires at the bend and creating a vertical line at a connection to each component of the PCB along the differential pair, wherein junctions of each vertical line and the two wires are separately defined as a pair of points;
calculating a first length between one terminal of the differential signal sender and a point of each pair of points on one wire;
calculating a second length between the other terminal of the differential signal sender and the other point of each pair of points on the other wire;
adjusting the lengths of the two wires of the differential pair if any difference between the first length and the second length does not fall within an allowable range;
establishing a simulation model of the layout comprising the differential pair and the components of the PCB; and
testing the functionality of the layout of the PCB.

8. The method of claim 7, wherein a length between one terminal of a first test point at one wire equals to a length between the other terminal and a second test point at the other wire.

9. The method of claim 7, wherein adjusting the two wires by twisting or looping the relative shorter one of the two wires of the differential pair adjacent to the bend point.

10. The method of claim 7, wherein the allowable range is from 0 mil to
$$\frac{X 2 * {10}^{9}}{5 * X 1 * N} mil ,$$
wherein X1 is a bit rate of differential signals transmitted through the differential pair; X2 is a transmission rate of the differential signals; and N is a ratio of a time of transmission one bit differential signals and a signal rise time of the differential pair.

11. A non-transitory storage medium storing a set of instructions, the set of instructions capable of being executed by a processor to perform a method for creating a layout of differential pair, the non-transitory storage comprising:
establishing a differential pair between a differential signal sender and a differential signal receiver in a layout of a PCB;
creating a vertical line at each bend point of an inner wire of two wires at the bend and creating a vertical line at a connection to each component of the PCB along the differential pair, wherein junctions of each vertical line and the two wires are separately defined as a pair of points;
calculating a first length between one terminal of the differential signal sender and a point of each pair of points on one wire;
calculating a second length between the other terminal of the differential signal sender and the other point of each pair of points on the other wire;
adjusting the lengths of the two wires of the differential pair if any difference between the first length and the second length does not fall within an allowable range;
establishing a simulation model of the layout comprising the differential pair and the components of the PCB; and
testing the functionality of the layout of the PCB.

12. The medium of claim 11, wherein a length between one terminal of a first test point at one wire equals to a length between the other terminal and a second test point at the other wire.

13. The medium of claim 11, wherein adjusting the two wires by twisting or looping the relative shorter one of the two wires of the differential pair adjacent to the bend point.

14. The medium of claim 11, wherein the allowable range is from 0 mil to
$$\frac{X 2 * {10}^{9}}{5 * X 1 * N} mil ,$$
wherein X1 is a bit rate of differential signals transmitted through the differential pair; X2 is a transmission rate of the differential signals; and N is a ratio of a time of transmission one bit differential signals and a signal rise time of the differential pair.
